(19) United States
(12) Patent Application Publication
(10) Pub. No.: US 2002/0066302 A1
(43) Pub. Date: Jun. 6, 2002

(54) Seat sensor calibration system and related method

(76) Inventors: James R. Hamm, Akron, NY (US); Rudy H. Arendt, Elma, NY (US)

Correspondence Address: JAMES W. PROSICA, Brooks & Kushman P.C., 22nd Floor, 1000 Town Center, Southfield, MI, 48075, US

(21) Appl. No.: 09/730,942

(22) Filed: Dec. 5, 2000

(51) Int. Cl. G01G 19/56; G01L 25/00

(52) U.S. Cl. 73/1.13

(57) ABSTRACT

The present invention is an seat sensor calibration system used to calibrate the output of a pressure sensor embedded in a vehicle seat. The embedded pressure sensor is used in a vehicle to determine the force which air bags should deploy during a collision. The seat sensor calibration system has an assembly for dropping a body weight form on a vehicle seat from a fixed height. The calibration system also has data acquisition electronics for controlling the positional of the body weight form over the seat and for measuring the output of the pressure system. The seat sensor calibration system acquires the output of the pressure sensor upon impact and then immediately after lifting the weight form from the vehicle seat.

### TECHNICAL FIELD

This invention relates to a method and apparatus for calibrating a seat sensor, and more particularly to calibrating a seat sensor in an automobile air bag system.

### BACKGROUND OF THE INVENTION

Government regulation require that air bags be installed in all newly manufactured vehicles. Some air bag systems are capable of sensing the weight of the seat occupants. Typically, such air bag utilize a pressure or weight sensor in order to accomplish this determination. Accordingly, there is a need that such pressure sensors be calibrated in order to function properly.

### SUMMARY OF THE INVENTION

It is an object of the present invention to provide a system and method for calibrating a vehicle air bag sensor system.

It is another object of the present invention to provide an air bag calibration system and method in which a weight is dropped on a vehicle seat in a near free-fall manner.

It is another object of the present invention to provide an air bag calibration system that can be operated under computer control.

The seat sensor calibration system (SSCS) of the present invention is used to calibrate the output of a pressure sensor associated with a vehicle seat. This pressure sensor in used in a vehicle air bag system to determine the weight of an occupant seated in a vehicle such that the air bags can deploy with the desired level of force depending upon the weight of the occupant. For instance, the air bag will deploy with a relatively lower amount of force when it is determined that a relatively lighter occupant is seated in the seat. The SSCS has an assembly for dropping a body weight form on a vehicle seat from a fixed height. The pressure sensor outputs a signal that is functionally related to the weight of the object that is dropped on the vehicle seat. The output signal upon impact is measured with a measuring device such as a computer, voltage meter, or a data acquisition system. (The output signal from the pressure transducer is first measured prior to impact.) The body weight form is dropped at approximately the same location on each vehicle seat to be calibrated. The body weight form is inhibited from moving to adjacent positions on the vehicle seat by guiding the body weight form during near-free-fall when the body weight form is dropped. This near-free-fall only deviates from a true free-fall by the small amount of friction induced in the guiding mechanism. After impact and acquisition of the pressure output, the body weight form is lifted off the seat and the output of the pressure sensor is measured. The measurements of the pressure sensor output upon impact and immediately after impact when the weight form is lifted provide the necessary information needed to calibrate a vehicles air bag sensor system so that the air bags deploy with a reduced force when a smaller vehicle occupant is seated on a vehicle seat.

### BRIEF DESCRIPTION OF DRAWINGS

FIG. 1 is a schematic of an embodiment of the seat sensor calibration system that uses a pivoting mechanism for positioning a body weight form over a vehicle seat.

FIG. 2 is a schematic of the free fall assembly used with the present invention;

FIG. 3 is an enlarged view of parts shown in FIG. 2;

FIG. 4 is a view similar to FIG. 1 showing parts in a different position;

FIG. 5 is a schematic of an embodiment of the present invention in which the free-fall assembly is mounted on an overhead beam;

FIG. 6 is an exploded view of the mounting system used to secure the free-fall assembly shown in FIG. 5;

FIG. 7 is a perspective view of an embodiment of the present invention that utilizing a translationally movable table for positioning the free fall assembly; and

FIG. 8 is an exploded view of the mounting system used to secure the free-fall assembly shown in FIG. 7.

### DETAILED DESCRIPTION OF THE PREFERRED EMBODIMENTS

Reference will now be made in detail to presently preferred embodiments and methods of the invention, which constitute the best modes of practicing the invention presently known to the inventor.

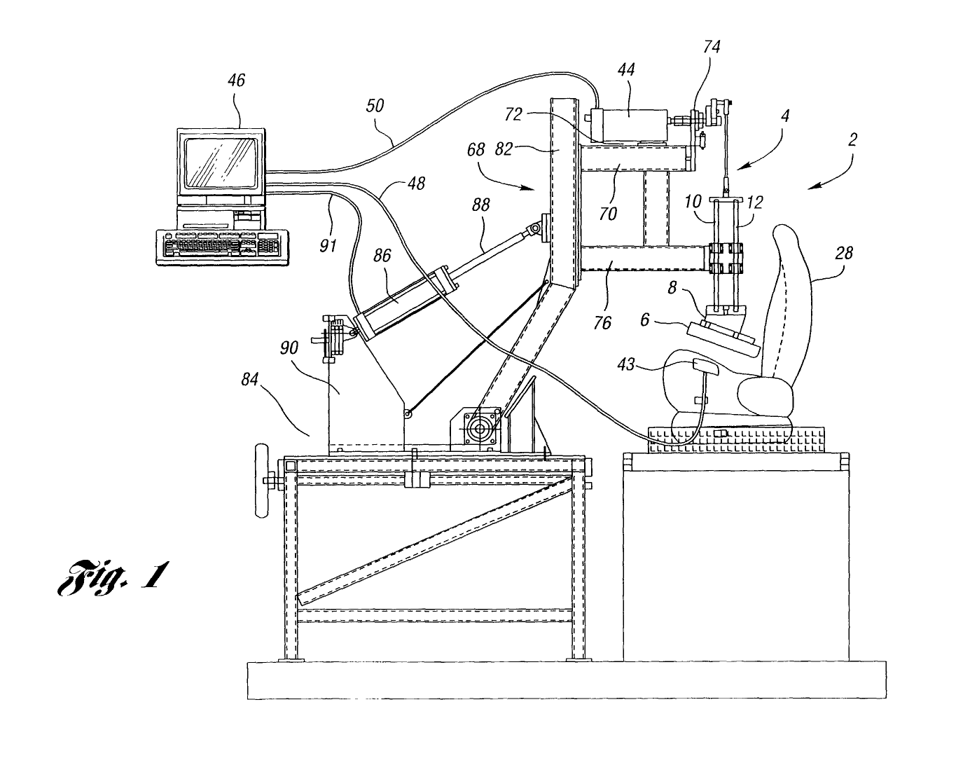

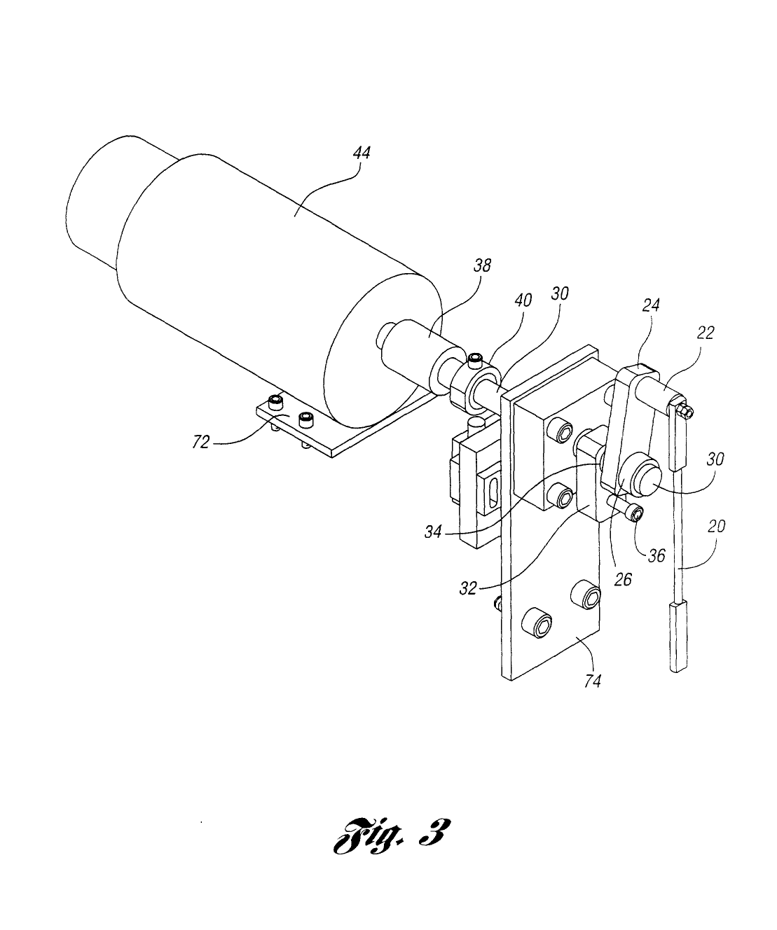

With reference to FIGS. 1, 2, and 3 a schematic of an embodiment of air bag sensor calibration system 2 is provided. Free-fall assembly 4 comprising body weight form 6 is attached to pedestal 8, which is preferably angular. The combination of body weight form 6 and pedestal 8 simulate the distribution of weight that an occupant exerts on a seat. Pedestal 8 is attached to guide bars 10, 12, 14, 16. Guide bars 10, 12, 14, 16 are attached to guide plate 18 which in turn is attached to cable 20. Cable 20 is secured to pin 22 which protrudes from cable arm 24. Cable arm 24 has a hole 26 on one end. The distance between pin 22 and the center of hole 26 determines the height from which body form 6 is dropped on vehicle seat 28. Preferably the distance between pin 22 and the center of hole 26 is between 1 and 5 inches. Drive shaft 30 feeds through hole 26. Cable arm 24 is not pinned to drive shaft 30 in any manner. Instead, cable arm 24 is free to rotate relative to drive shaft 30. Drive arm 32 has hole 34 through which drive shaft 30 is also positioned. However, drive arm 32 is pinned to drive shaft 30 such that drive arm 32 moves is a similar fashion to the hands of a clock when drive shaft 30 is rotated. Drive arm 32 is capable of being moved in a clockwise or counter clockwise direction. Drive pin 36 protrudes from drive arm 32 at a distance of approximately 1.5 inches. Drive pin 36 contacts cable arm 24 during rotation of drive arm 32 and drive shaft 30. This contact causes cable arm 24 to move in unison with drive arm 32 during the upward swing from the 6 o'clock to the 12 o'clock position. Drive shaft 30 is attached to motor shaft 38 with coupler 40. Motor shaft 38 emerges from electric motor 44.

During operation of the SSCS, cable arm 24 is stopped at the apex of rotation which is approximately the 12 o'clock position. At this position, body weight form 6 is suspended at a fixed height over vehicle seat 28 which has imbedded within it pressure sensor 43. A preferred pressure sensor embedded within vehicle seat 28 is the PODS-B air bladder available from Delphi-Delco Electronic Systems. The output of pressure sensor 43 is measured prior to impact by computer 46 which is equipped with an analog-to-digital converter through interface cable 48. A measurement during impact is commenced by operating electric motor 44. When drive arm 32 rotates slightly past the 12 o'clock position, gravity causes cable arm 24 to disengage from drive arm 32 and swing downward towards the 6 o'clock position. Accordingly, body weight form 6 falls towards and impacts vehicle seat 28. Upon impact the output of pressure sensor 43 embedded in vehicle seat 28 is measured via computer 46. Drive arm 32 continues rotating until a position slightly before the 6 o'clock position, at which point a limit switch causes drive arm 32 and motor 44 to stop. Computer 46 via interface cable 50 causes electric motor 44 and drive arm 32 to start rotating in the upward swing after the impact measurement is made. Drive arm 44 makes contact with cable arm 24 at approximately the 6 o'clock position. The upward rotation of drive arm 32 once again moves cable arm 24 towards the 12 o'clock position. Drive arm 32 is then stopped at approximately the 12 o'clock position. A limit switch is used to automatically stop drive arm 32 at this position. Once body weight form 6 is lifted from vehicle seat 28 a third measurement is made of the output of the pressure sensor. The measurements of the output of pressure sensor 43 output upon impact and immediately after impact when body weight form 6 is lifted provide the necessary information needed to calibrate a vehicles air bag sensor system so that the air bags deploy with a reduced force when a smaller vehicle occupant is seated on a vehicle seat.

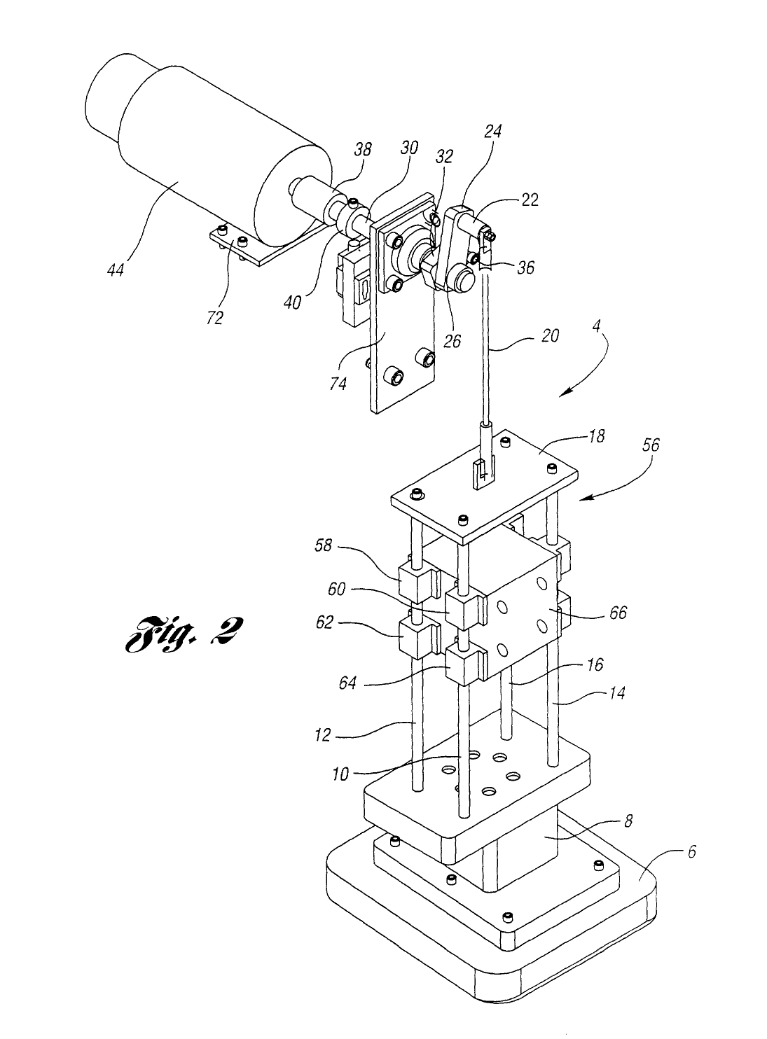

With reference to FIG. 2, guiding mechanism 56 is described. During free-fall, body weight form 6 is directed by guides 58, 60, 62, 64 and the same type of guides on the opposite face of grid frame 66. Bearing are inserted within guides 58, 60, 62, 64 and the guides on the opposite face so that friction with guide bars 10, 12, 14, 16 is reduced. Guide bars 10, 12, 14, 16 are inserted through guides 58, 60, 62, 64. Guides 58, 60, 62, 64 and its guides on its opposite face are attached to guide frame 66.

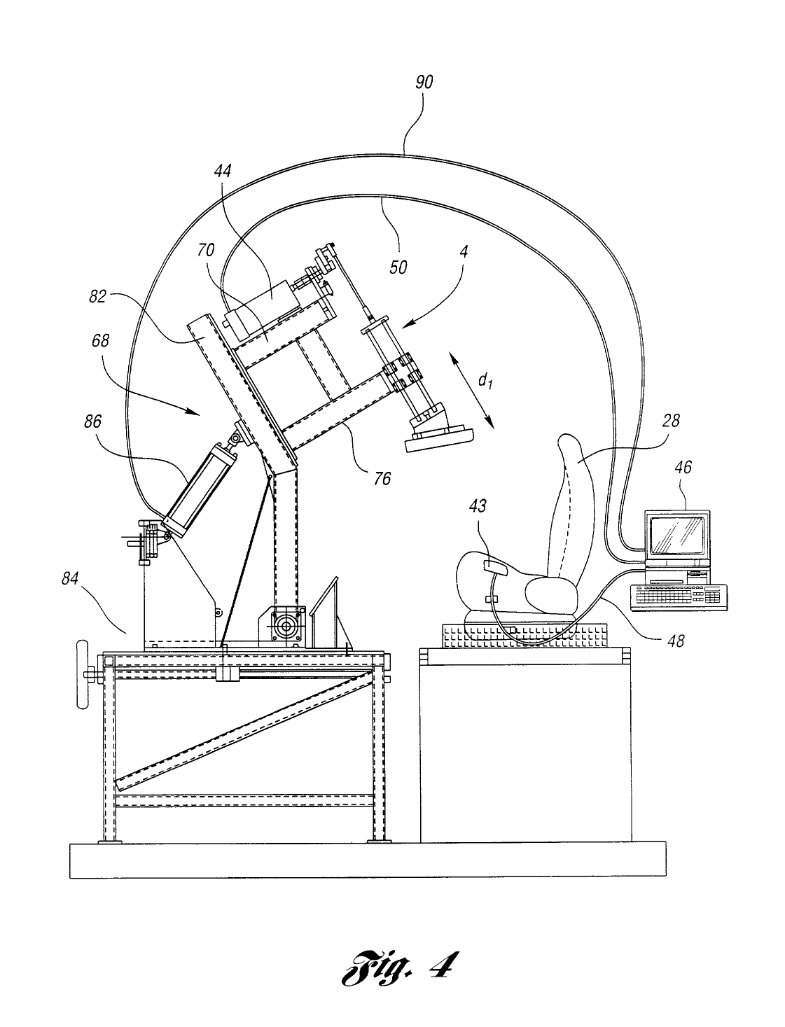

The present invention includes several variations for mounting guide frame 66 and electric motor 44. With reference to FIGS. 1-4, a particular embodiment of the present invention is provided. The SSCS is mounted to frame 68 which pivots towards and away from vehicle seat 28 when calibration measurements are performed. Electric motor 44 is mounted to arm 70 by plate 72 and by shaft plate 74. Guide frame 66 is mounted of the front face of arm 76. Arms 70 and 76 extends from post 82. Post 82 is attached to base frame 84 such that post 82 is able to pivot relative to base frame 84. Drive 86 attaches to post 82 via rod 88 on one end and mount 90 on the opposite end such that post 82 pivots away from vehicle seat 28 when rod 88 is retract by drive 86. Drive 86 can either be a pneumatic cylinder or an electromechanical linear actuator. The motion of actuator 86 is controlled by computer 46 via interface cable 90. Accordingly, frame 68 pivots away from vehicle seat 28 in direction d₁ when vehicle seat 28 is to be removed and another seat moved into position to be calibrated. FIG. 4 illustrates frame 68 in the away position.

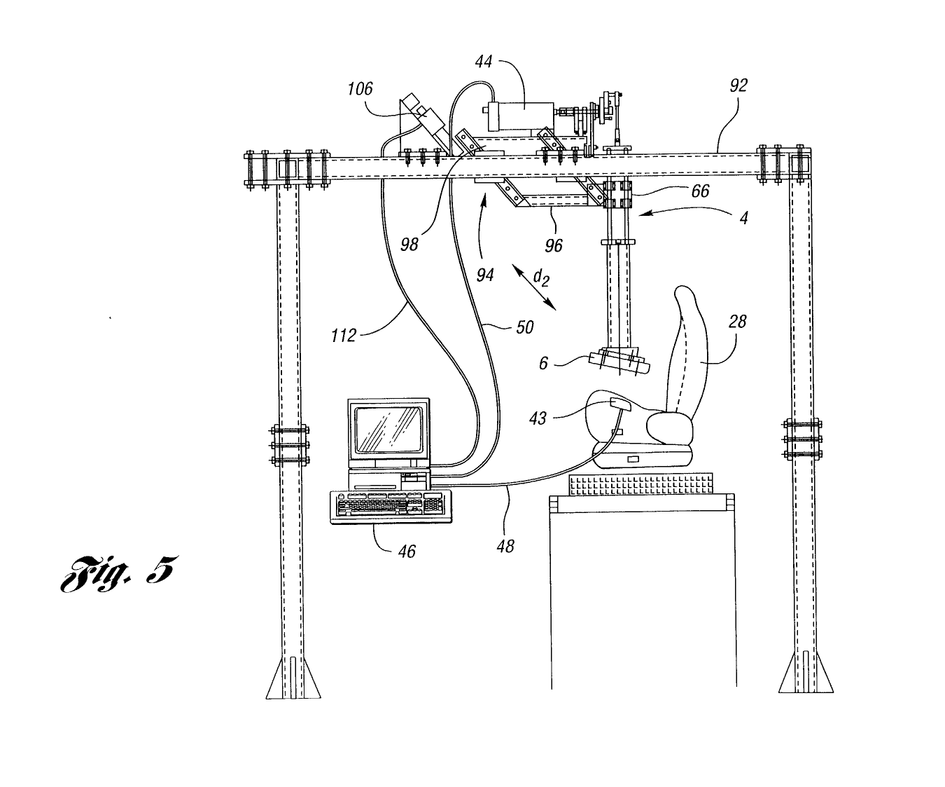

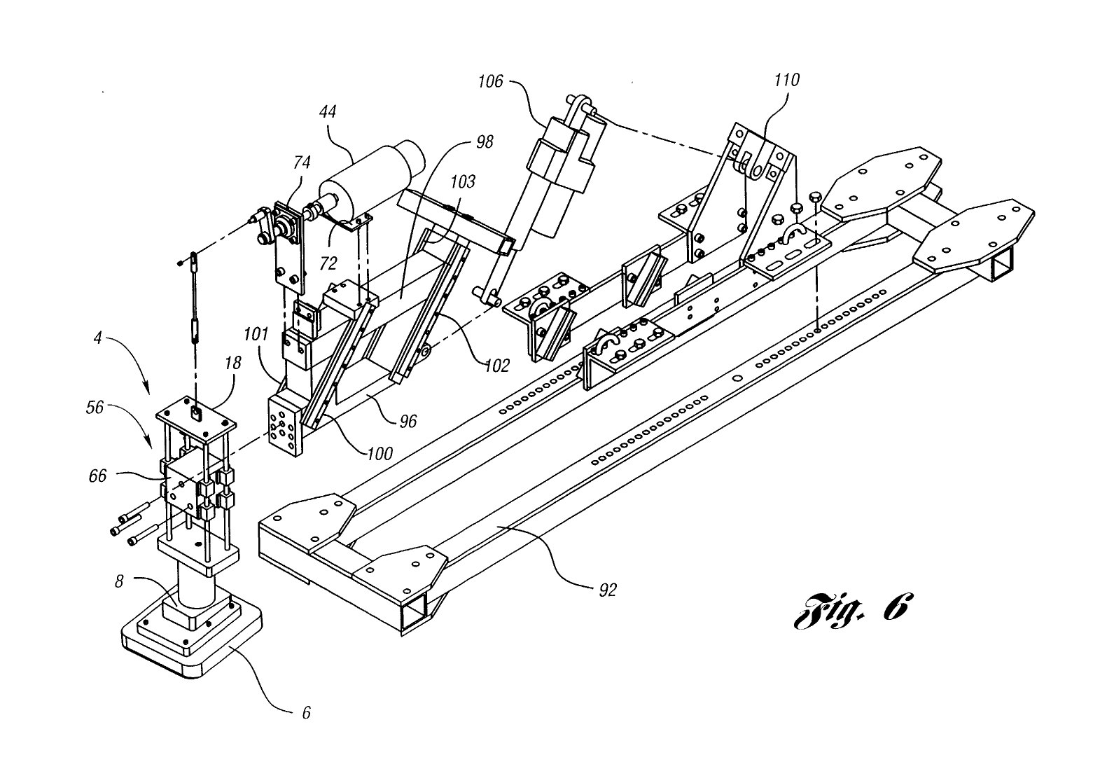

With reference to FIGS. 5 and 6 another embodiment of the present invention is provided. Free-fall assembly 4 is mounted to overhead beam 92. Translation assembly 94 moves free-fall assembly 4 over vehicle seat 28 when a measurement is to be commenced and away from vehicle seat 28 when vehicle seat 28 is to be removed and another seat positioned for measurement. Guide frame 66 attaches to support arm 96 and electric motor 44 attaches to support arm 98. Brackets 100, 101, 102, and 103 hold support arms 96, 98 in place. Actuator 106 contacts support brackets 102 and 103 such that free-fall assembly 4 is move along direction d₂ towards and away from a vehicle seat as desired. Actuator 106 mounts on support frame 110 which is mounted on overhead beam 92. The motion of actuator 106 is controlled by computer 46 via interface cable 112. Actuator 106 is preferably an electromechanical linear actuator.

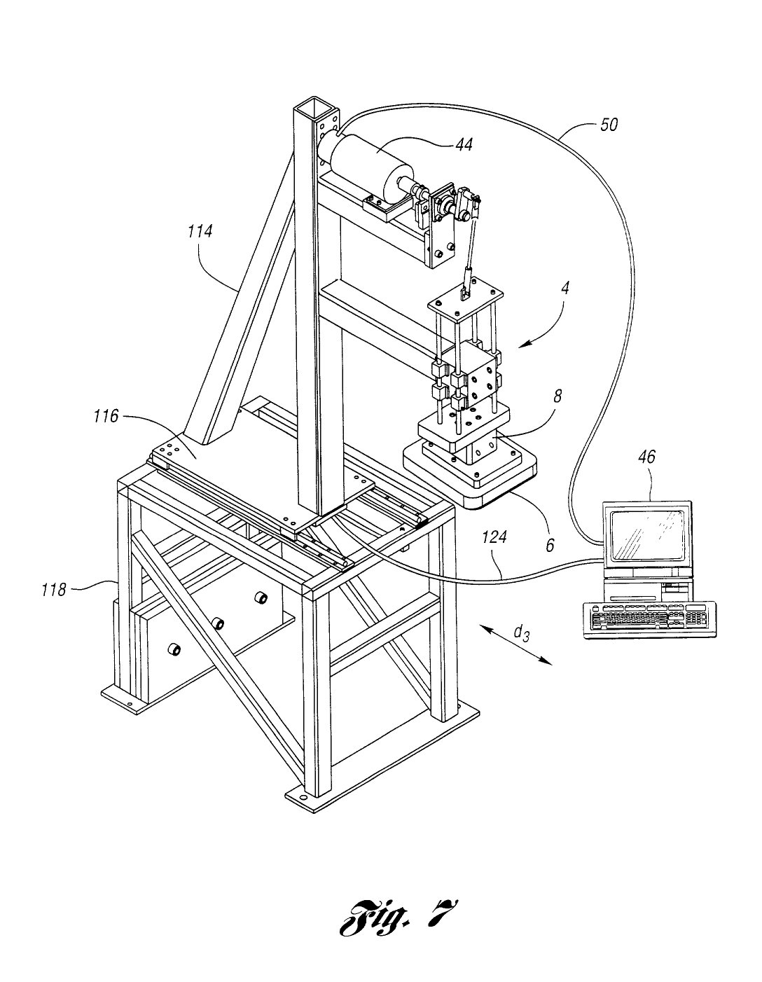

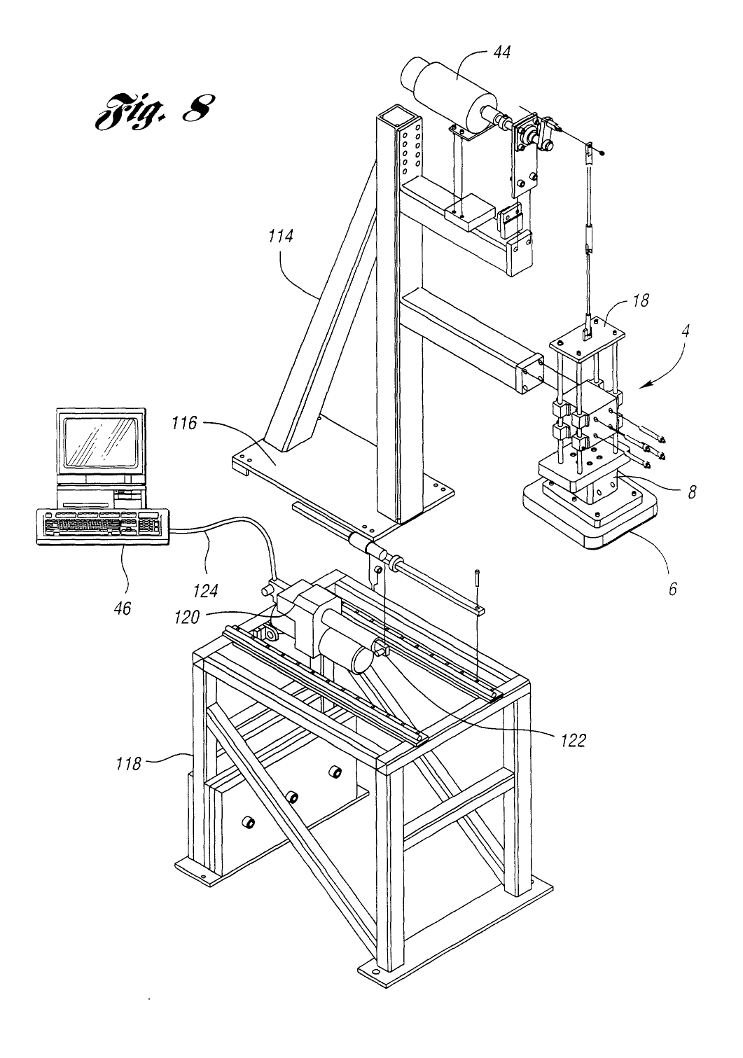

With reference to FIG. 7 and 8, another embodiment of the present invention is provided. The free-fall assembly 4 is mounted to frame 114. Frame 114 is attached to translation table 116. Translation table 116 moves is a linear fashion relative to base frame 118. A motor connected to base frame 118 allows translation table 116 to move relative to base frame 118. During operation translation table 116 carries frame 114 and free-fall assembly 4 along direction d₃ to a position such that body weight form 6 is positioned over the seat to be calibrated. When the measurement is complete, translation table 116 carries free-fall assembly 4 away from the vehicle seat. Actuator 120 which is mount within base frame 118 is in communication with translation table 116 via connector 122. Operation of actuator 120 causes movement of translation table 116 in the d₃ direction. The motion of actuator 120 is controlled by computer 46 via interface cable 124. Actuator 120 is preferably an electromechanical linear actuator.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. An air bag sensor calibration system for calibrating a pressure sensor in a vehicle seat, said system comprising:
a body sufficiently free-fallable from a fixed drop height to the vehicle seat so that an impact pressure is induced in the seat; and
a measuring device adapted to be connected to the sensor in the seat capable of determining an impact pressure reading and a pressure reading after the body weight form is lifted from the vehicle seat.

2. The air bag sensor calibration system as set forth in claim 1 further comprising a guide mechanism wherein the body weight form is inhibited from moving to positions adjacent to a predetermined impact location on the vehicle seat.

3. The air bag sensor calibration system as set forth in claim 1 wherein the measuring device is a computer with an analog-to-digital converter.

4. The air bag sensor calibration system as set forth in claim 1 wherein the measuring device is a programable acquisition system.

5. The air bag sensor calibration system as set forth in claim 1 wherein the measuring device is a voltage meter.

6. The air bag sensor calibration system as set forth in claim 1 further comprising:
a power operated rotatable drive shaft;
a drive arm wherein the drive arm is in communication with the drive shaft; and
a cable arm freely rotatable relative to the drive shaft and in communication with the body weight form,
wherein rotation of the drive shaft causes the drive arm to rotate such that rotation of the drive arm from a down to an up position causes the cable arm to rotate and lift the body weight form.

7. The air bag sensor calibration system as set forth in claim 6 wherein the cable arm freely falls from the up to the down position causing the body weight form to drop in a sufficiently free-fallable manner to induce an impact response in the pressure sensor.

8. The air bag sensor calibration system as set forth in claim 7 further comprising a frame wherein the power operated rotatable drive shaft and body form weight are mount on the frame.

9. The air bag sensor calibration system as set forth in claim 8 wherein the frame is capable of positioning the body weight form at a positioning for calibrating a vehicle seat and at a position away from the vehicle seat.

10. A method of calibrating a seat sensor system, the method comprising:
measuring the electrical output of the pressure sensor;
dropping a body weight form on a vehicle seat wherein a pressure sensor is embedded within the vehicle seat;
measuring the electrical output of the pressure sensor on impact of the body weight form with the vehicle seat;
lifting the body weight form from the vehicle seat; and
measuring the electrical output of the pressure weight immediately after the body weight form is lifted from the vehicle seat.

11. The method of claim 10 wherein the body weight form is dropped in a manner such that the body weight form impacts a predetermined location on the vehicle seat.

12. The method of claim 11 wherein the body weight form is inhibited from moving to positions adjacent to the predetermined location on the vehicle seat.

13. The method of claim 10 wherein the electrical output of the pressure sensor on impact of the body weight form with the vehicle seat is measured by a computer having an analog-to-digital converter.

14. The method of claim 10 wherein the electrical output of the pressure sensor on impact of the body weight form with the vehicle seat is measured by a programmable logic controller.
